(19) United States
(12) Patent Application Publication
(10) Pub. No.: US 2013/0113975 A1
(43) Pub. Date: May 9, 2013

(54) Projector Image Correction Method and System

(71) Applicant: Peter Gabris, Kennesaw, GA (US)

(72) Inventor: Peter Gabris, Kennesaw, GA (US)

(21) Appl. No.: 13/664,474

(22) Filed: Oct. 31, 2012

Related U.S. Application Data
(60) Provisional application No. 61/555,832, filed on Nov. 4, 2011.

(51) Int. Cl. G03B 21/14; H04N 5/222

(52) U.S. Cl. 348/333.1; 353/121; 348/E05.137

(57) ABSTRACT

Disclosed is a projector image correction method and system that actively modifies a projected image based on observed distortions in the reflected image from the projection surface. The method and system utilize a projector for displaying an image or motion picture on a screen, a camera for capturing the projection surface and projected image, an image correction unit for processing the differences between the captured image and the projected image, and an algorithm for interpreting the camera and projector image differences and effectuating the active correction of the projector image. Correction data from the camera image is utilized to correct the projected image by superimposing the data over the image for each frame, accounting for image distortion due to rough or multi-colored surfaces that otherwise change the projected image quality on the projection surface.

### CROSS REFERENCE TO RELATED APPLICATION

This application claims the benefit of U.S. Provisional Application No. 61/555,832 filed on Nov. 4, 2011, entitled “Adaptive Correction of the Projection Plane Projections.” The above identified patent application is herein incorporated by reference in its entirety to provide continuity of disclosure.

### BACKGROUND OF THE INVENTION

1. Field of the Invention

The present invention relates to image projection systems. More particularly, the present invention pertains to a system for projecting images or video on diffuse reflection surfaces or colored surfaces and actively adapting the projected image to account for distortions created by projection surface imperfections and color differences when comparing the image to be projected and actual image reflected from the projection surface.

Electronic image and video projectors are common household and commercial products that have become increasingly affordable in recent years, enabling their widespread use in a number of environments, including residences, classrooms and the workplace. Conventional projectors allow groups to view moving or still images on a projector screen that provides a flat and uniform surface upon which to project the images. The flat surface allows the user to visualize the image without disturbing the intended image through distortion or color alterations. The screen helps to reduce imperfections, textures or color patterns that may otherwise be present if projected onto a bare wall surface. Image projectors themselves are readily transportable, as they are generally compact electronic devices having a projection lens and an electronic housing; however their accompanying screens are typically bulky and difficult to carry over distances or stow while traveling, as the screen must be sized large enough for the corresponding projection image size. If an individual attempts to use a projector without the accompanying screen, it becomes readily apparent the advantages provided by the screen over an unprepared surface. Surfaces such as interior walls can have surface imperfections, textures and sometimes non-uniform colors, whereupon the projected image thereon becomes distorted and the clarity is reduced.

Projection of an image against a wall surface having surface imperfections or color patterns affects the reflectivity of the image that is viewed by the human eye. Interior walls, including drywall surfaces, are diffuse reflection surfaces, where radiation of a projected image reflects equally or near-equally at all reflection angles from the wall surface. This makes the projected image visible to all in a room; however unprepared surfaces such as interior drywall have inherent textures that distort the image reflection and reduce the quality of the projected image being seen by onlookers. The distorted image reduces its quality and makes the image less clear or sharp than as intended by the projector.

The present invention discloses a projector system and method that corrects and prevents images from becoming overly distorted when viewed on irregularly textured or colored wall surfaces. In conjunction with the projector, an equipped camera captures the projection surface image and adapts the projection image such that it may be clearly seen on the irregular or colored surface without distortion. An image of the projection area is obtained by an accompanying camera in conjunction with the projector, whereafter the capture image is inverted and superimposed over the projection image or video. The captured image is processed to serve as a correction to the projected image based on the projection surface, correcting for surface irregularities and variations with respect to color. The projected image with the applied correction is captured by the camera again and analyzed for residual imperfections. Consequently the superimposed image and the superimposing coefficient are improved. This provides a user with the freedom to display a film or make a presentation without having the image distorted when presented against and unprepared surface. The projector also is employable in home or theatre environments with less than ideal lighting or with projection surfaces that are not completely perfect and include inherent surface irregularities.

2. Description of the Prior Art

Devices have been disclosed in the prior art that relate to image projectors and light correction means therefor. These include devices that have been patented and published in patent application publications, and generally relate to projector image correction devices that utilize varying methods and elements for reducing color distortion or surface flaws. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 7,677,737 to Lonn discloses a projector adaption and self-calibration device that includes a camera to capture a picture image of the surface the projector is forming its image. The device identifies the lightest portion of the projected image and adjusts the setting of the projector based on a comparison of an intensity of the identified lightest portion to an intensity of the portion of the area surrounding the projected image. The device compares a point in the projected image to a point in the surrounding area to adjust the color of the projector image based on ambient light conditions and the contrast, color and intensity required in that ambient condition. The Lonn device is adapted to adjust the intensity and brightness of the projected image based on ambient conditions and the light on a point surrounding the projected image. While the device includes a secondary camera in conjunction with a projector, the use and function of the camera diverges from the use and novel aspects of the present invention, which process the actual projected image itself and modifies it accordingly based on correction data derived therefrom.

U.S. Pat. No. 6,715,888 to Raskar discloses a method and system for displaying images on a curved surface using a plurality of projectors. The input image is acquired by a camera fixed to one of the projectors to determine a quadratic transfer function so as to warp outgoing projected images by the quadratic transfer parameters, which allows the projected image to be displayed without distortion on a curved surface. The result is a shape-adaptive system that limits local distortions in the projected image when projected onto a curved display surface, and more specifically to quadratic surfaces. While Raskar provides a means to modify a projection image to correct for surface irregularities, the method requires a plurality of projectors in order to function. The present invention contemplates a single projector and projector image correction means.

Further, U.S. Pat. No. 7,339,596 to Tajima discloses a projector color correction method using spectral reflectance of a projection plane or color information under a light source. A conversion matrix is calculated and mixing amounts of red, green, and blue colors are corrected by the conversion matrix and thereafter projected from the projector. The goal is provide an image that is of the correct color, even when projected against a wall of a particular color or pattern, wherein the colors of the image are adjusted to account of the wall color difference. The Tajima device uses a color sensor to get the overall color of the area, we are using camera to get each individual spot where an individual image pixel will be projected, and corrects the image against unified color of the background. The device contemplates use with analog projectors, where a 3×3 matrix representing a 3 color (RGB) transformation modifies the color spectrum of the exiting image. The present invention utilizes a digital projector (discrete) having an image built from pixels. An m×n matrix representing pixels of digital image is created, where each pixel can be 3 numbers if the image is processed as RGB, or RGB adjustment is utilized in conjunction with other color light producing means.

Finally, U.S. Pat. No. 6,412,956 to Fujita discloses an image projection system that comprises a means for projecting an image onto a projection screen from the rear surface thereof. An image capturing means is provided for capturing the projected image on the screen, whereafter a means of removing influences of external light is applied and a correction value is computed for removing the external light influences from the projected image. The corrected image information is supplied to the projector such that defects in the projected image due to light influences on the screen are suitable reduced or removed in the image. The Fujita device is a rear projection screen suited for a television or large projection screen structure. Light influences are accounted for, while the present invention contemplates correction for surface irregularities, and non-planar projections that would otherwise create distortions in the projected image.

The present invention provides a method and a system for adapting a projection image based on a calculated correction factor derived from the projection surface. A secondary camera develops an image of the projection surface and superimposes a correction on the projected image to reduce distortion or clarity issues when the projection surface is not completely planar and smooth. The disclosure herein describes a method and algorithm for accomplishing this goal using a secondary camera source in conjunction with the projector. It is submitted that the present invention is substantially divergent in design elements from the prior art, and consequently it is clear that there is a need in the art for an improvement to existing projection correction devices. In this regard the instant invention substantially fulfills these needs.

### SUMMARY OF THE INVENTION

In view of the foregoing disadvantages inherent in the known types of projector devices now present in the prior art, the present invention provides a new projector and correction system that can be utilized for providing convenience for the user when projecting an image or motion picture onto a projection plane having surface imperfections.

It is therefore an object of the present invention to provide a new and improved projector system that has all of the advantages of the prior art and none of the disadvantages.

It is another object of the present invention to provide a projector correction method and system that utilizes a high resolution camera at least equal to the projector resolution to identify the surface irregularities of a projection surface and provide a correction factor for the projected image that accounts for inherent distortion of the irregular surface reflectivity.

Another object of the present invention is to provide a projector correction method and system that accounts for minor surface irregularities and color variations by correcting each pixel of the projector, not one that corrections for large surface nonlinearities and distortions therefrom.

Yet another object of the present invention is to provide a projector correction method and system that pairs a camera and projector, and includes a processor and internal memory to calculate correction data that is superimposed on the projected image to correct for reflectivity distortions.

Still yet another object of the present invention is to provide a projector correction method that contemplates a working algorithm for collecting and processing the projection surface data and calculating pixel by pixel adaptations that correct distortions caused by surface textures, color patterns and other irregularities not present in perfectly planar projection and uniform surface.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 is a schematic composition diagram of the apparatus and its function.

FIG. 2 is a flowchart of the image or video projection and correction process.

### DETAILED DESCRIPTION OF THE INVENTION

Reference is made herein to the attached drawings. Like reference numerals are used throughout the drawings to depict like or similar elements of the active projector distortion correction method and device. For the purposes of presenting a brief and clear description of the present invention, the preferred embodiment will be discussed as used for correcting a projected image for distortions created by irregularities or imperfections on the projection surface. The figures are intended for representative purposes only and should not be considered to be limiting in any respect.

The present invention provides a method and system having a means to correct a projected image on a pixel-by-pixel basis based on the projection surface quality. Distortions created by surface irregularities, textures or colors are accounted for, where a matrix of correction data is generated and superimposed on the projected image, one pixel at a time to prevent distortion of the image on the projection surface. Large nonlinearities of and large non-planar portions of a projections surface are not handled, but rather reflectivity distortions caused by small irregularities of the surface plane are particularly accounted for by the computed correction of the image. A digital camera functions in conjunction with the projector lens, whereby a microprocessor, computer memory and power source function to provide an active correction means for image distortions perceived from the image reflected from the projection surface, thereby improving image quality of the projection image and reducing the limitations of unprepared projection surfaces and distortions therefrom.

As a summary of the underlying theory and means of fulfilling the purpose of the present invention, the following illustrates the principles being utilized to first capture a projector surface image, compute a correction factor for each pixel, and superimpose the correction over a projected image to reduce distortions created by the projection surface.

Let matrix A_{m×n}=[a_{i,j}] represent pixels of the image to be projected having m rows of pixels and n pixels in each row. The a_{i,j} is the light/color value of the pixel in the row i and the column j.

Let matrix B_{m×n}=[b_{i,j}] represent the wall area on which the image A is projected on. The b_{i,j} is the color of the spot the pixel a_{i,j} is projected on. More accurately, the b_{i,j} value represents the reflectivity of the spot, defined as the fraction of incident radiation reflected by the projection surface.

Let matrix C_{m×n}=[c_{i,j}] represent pixels of the image A reflected by the area B. The c_{i,j} is the a_{i,j} pixel image reflected by the spot b_{i,j}, which is captured in the present method by a secondary camera.

Matrices A, B and C are related by the reflection function:

c_{i,j}=f(s_{i,j},b_{i,j})

In an ideal case of absolutely white and perfectly reflective surface B, the reflected image C would be the same as the original image A:

c_{i,j}=f(a_{i,j},ideal white)=a_{i,j}

In a real situation when the projection area spot b_{i,j} is neither perfectly reflective nor ideally white, the reflection can be described as:

c_{i,j}=f(a_{i,j},white)=a_{i,j}±white noise

When an image A_{white} consisting of white color in all pixels (white image):

∀a_{i,j}=white

is projected over the projection area B that is neither even (irregular/textured surface) nor white, then the C is the image of the projection area

c_{i,j}=f(white,b_{i,j})=b_{i,j}±white noise≅b_{i,j}

The reflectivity of the spot b_{i,j} that is not white will peak around the wavelength of the b_{i,j} color. This creates color distortion of the projected image. The color distortion can be corrected either:
By decreasing the light of the projected pixel a_{i,j} in the wavelengths around the color of b_{i,j}, or
By increasing the light of the projected pixel a_{i,j} in all wavelengths other than the color of b_{i,j}.
   While both options would correct the distortion of the color of a_{i,j} in c_{i,j}, the first option would likely make the spot darker than the rest of the image, while the second option would likely make the spot lighter. Therefore a combination of both options should be used in a way that will balance the intensity of individual pixels of the corrected image C.

Let matrix B̅_{m×n}=[ b̅_{i,j}] represent corrections of all pixels. Each b̅_{i,j} pixel is created from medium intensity white by decreasing the light intensity of the color of the spot b_{i,j} and increasing light intensity of all other colors. The ratio of increasing and decreasing the lights of individual pixels are balanced over the whole image as described earlier. We will call the image represented by the matrix B̅ inverted image B. Projecting the image B̅ at the area B would, in ideal conditions, make the image B disappear:

c_{i,j}=f( b̅_{i,j},b_{i,j})=white±white noise

The same change that was done with the white image in the previous paragraph can be performed on the image intended for projection. Each a_{i,j} is modified by decreasing the light intensity of the color of the spot b_{i,j} and increasing light intensity of all other colors. We will call this process of combining the two images superimposing and we will mark it as image addition:

superimposing inversion of B on A≡∀(a_{i,j}+ b̅_{i,j})

When we merge the inverted projection area image formula f( b̅_{i,j},b_{i,j}) with the formula for using the white background f(a_{i,j},white) we get:

c_{i,j}=f(a_{i,j}+b_{i,j})=a_{i,j}±white noise≅a_{i,j}

This is how superimposing of the inversion of the image of the projection area over the projected image can remove the image of the projection area from the observed final image, and thus remove its inherent distorting qualities.

The inverted image of the projection area can be approximated by analysis of differences between the projected image A and the reflected image C delivered by the camera. Differences between those two images shall be attributed to the projection screen image:

b̅_{i,j}≅\tilde{b}_{i,j}=c_{i,j}−a_{i,j}

The estimate will be less accurate at dark spots of the image a_{i,j}. However, those are of the least consequence since the color distortion of dark spots is comparatively low.

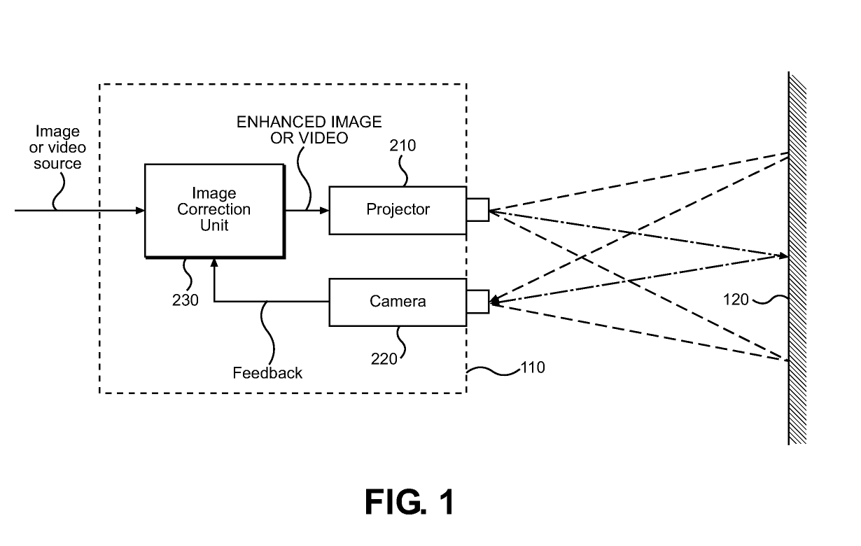

Referring now to FIG. 1, there is shown a schematic diagram of the device of the present invention. The device includes a housing 110 having a first projector 210 and projector lens for projecting still or motion pictures onto a projection surface 120, and a camera 220 for capturing a digital image of the area of the image projected onto the projection surface 120. The digital image from the camera 220 is processed by an image correction unit 230, which comprises a process and computer memory for operating the steps and algorithms that process the differences between the captured camera image 220 of the reflected projector image with that of the intended projector image 210. Differences caused by reflectivity distortion, through surface irregularities or surface 120 color, are accounted for and corrected in the image correction unit 230. The corrected image is then projected through the projector, whereby the system operates as a control loop for active correction of the projected image based on the projection surface reflectivity characteristics and the feedback received from the camera 220. The source image or video is therefore corrected based on this input to improve clarity and remove distortion of the reflected or perceived projection image.

The camera 220 image is reviewed pixel-by-pixel and a correction factor is provided for each pixel to remove distortions perceived from the wall reflection, thereby adapting the outgoing projector image by superimposing the correction factor on the projector 210 image in a pixel-by-pixel process. Because of this, it is desired for ease of programming to provide a matching or similarly designed camera and projector lens. Higher camera resolution can be accounted for, but equal pixel count from each lens is easiest to handle and develop correction factors for, if provided a design choice when constructing the present invention. The camera angle should further be encompassing of the projector lens' projection area, whereby the camera captures the entire reflected image. Finer resolution cameras and cameras of greater color sensitivity will afford better adaptation of the projected image and thus improved distortion removal provided by the present system.

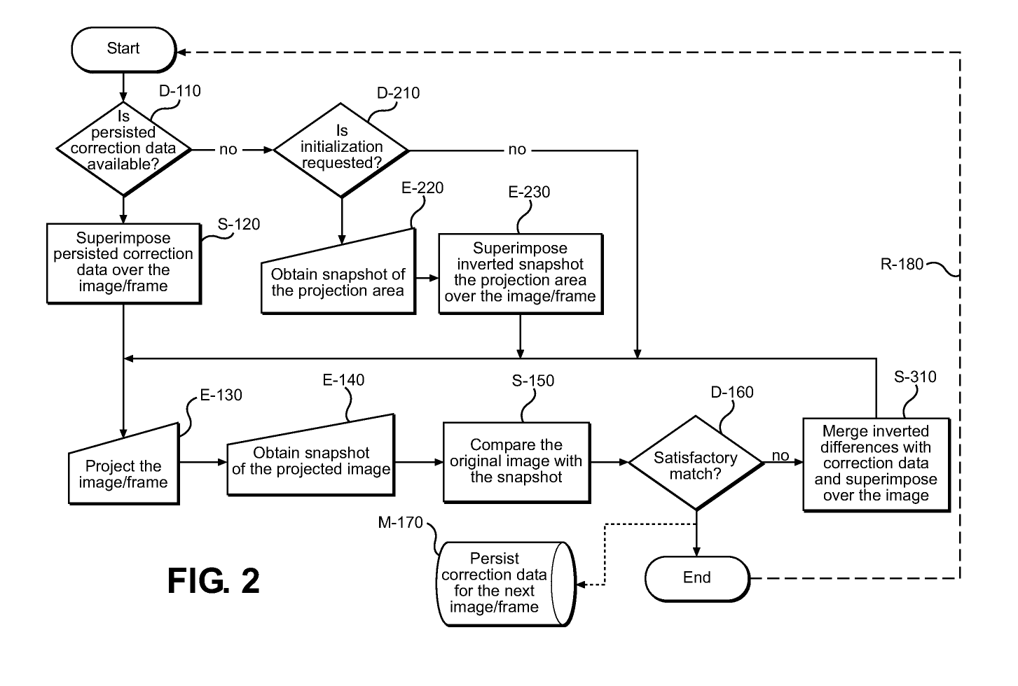

Referring now to FIG. 2, there is shown a flow chart diagram of the present method and accompanying device, whereby the flow diagram outlines the operational logic and process steps. The process initiates with an image or first frame of input video to be projected being received from an image source (computer video out, optical drive, etc.). At the first decision step D-110, corrected data M-170 stored on computer memory within the device image correction unit is checked for the availability of persisted correction data that has previously been processed. Persisted correction data comprises the correction matrix B̅_{m×n} and empirical coefficients that control the means of superimposing data over the image to be projected for processing of corrections based on perceived distortions created by the projection surface. When the device is initialized and a first image is processed, correction data is not available and the processing is passed to the decision step D-210.

The second decision step D-210 controls initialization of the correction data. This initialization is an optional step that involves projecting a white image and extracting a correction matrix b_{i,j}≅f (white, b_{i,j}). Initialization D-210 can be controlled by an external switch, system parameter, results of the past self-learning process of the device, or completely left out, as desired by the user. If the initialization of the correction data is left out, steps E-220 and S-230 of the presented flowchart can be ignored and processing from the negative decision of the step D-210 proceeds directly to the step E-130. In a case when the initialization D-210 of the correction data is not requested, the processing is passed to the step E-130 and an approximation of the correction data is derived from the difference between the projected and the observed image b̅_{i,j}=\tilde{b}_{i,j}=c_{i,j}−a_{i,j}. Initialization is a calibration of the system using input from the projection surface to generate correction data prior to the first projection image being displayed, whereby the first image can be accurately corrected.

If initialization is requested, processing is passed from D-210 to E-220. Initialization of correction data is performed by projecting a white calibration image (CI) or a set of calibration images from the projector and onto the projection surface, where a camera snapshot of each calibration image (CI) is obtained by camera for processing. The calibration image (CI) is either a white rectangle of equal size as the projected image or video or it is a set of images that are white having various light intensities that provide information about the pattern visible on the projection area when illuminated by white light color that is evenly distributed with the same intensity at each part of the projection area. A set of color calibration images can further be used to obtain the same information if desired. This establishes a baseline for the projection surface and for data to be gathered for distortion correction.

The following is a recitation of the derivation of correction data for removing the projector image distortions based on the given projection surface via processing of the calibration image. For simplicity, the process is described with the single calibration image (CI) obtained by projection of all white pixels or white rectangles (WR≡white). Obtaining the correction data from a set of calibration images can be inferred from the same process, taking into the consideration the criteria of how the set of calibration images was created. The processing of a calibration image where the projection area image (CI) received from the camera is larger than the projected image involves properly locating spots b_{i,j} corresponding to reflected pixels a_{i,j}, where without the proper transformation this would not be usable. Methods currently employed in the art for recognizing the differences between the projected image and the received image, and further the correction and extraction of the b_{i,j} are well known and are not a subject of novelty of the present invention. However, these methods are a critical step for processing the calibration image for differing sized camera and projector images. The following steps are mentioned here for the sole purpose of describing a complete process so as to fully describe the method of the present invention. These known steps include:
1. Recognize the reflection of the calibration image of all white rectangles (WRs) projected by the projector inside of the calibration image (CI) obtained by the camera. Because of the different position and characteristics of the projector and the camera lenses, the (CI) area obtained by the camera will not be the same as the area of the projected image WRs on the projection surface. The only thing that is essential is that the image obtained by the camera contains all the area where the projector will project the image WRs. The projected calibration image will usually be distorted inside of the image received from the camera. The distortion is very close to quadrilateral and therefore edges of the projected image can be recognized in the received image. The area inside of those edges is the image of the projection surface we will use for corrections.
2. Extract the projection surface image from the quadrilateral area of the calibration image of the obtained image.
3. The received image B_{m×n}=[b_{i,j}] is obtained by transformation of the projection surface to the original size and shape if the calibration image.
4. Invert B to obtain the image B̅_{m×n}=[ b̅_{i,j}] (superimposable correction) to be superimposed over the projected images later. The inversion function ensures that each pixel of the inverted image has value inversely proportional to the reflected color and the color of the pixel at the same location (position) where the pixel a_{i,j} is projected in the projection surface.

The result of the initialization is the image of the inverted projection area in the form of the correction matrix B̅_{m×n} stored in the correction data storage memory that is part of the image correction unit. Information about the position of the area of the projected image inside of the camera image is persisted in the correction data memory as well. Processing continues to the step S-230.

At the step S-230, or at step S-120 if persisted correction data is available upon start, the correction image B̅ is superimposed over the image to be projected. The purpose of this image modification prior to projection is to achieve the luminescence of each pixel to be projected on a spot having high reflectivity of light and its color reduced to match the lower reflected luminescence of another pixel projected at a darker spot. Execution proceeds to step E-130. Step E-130 uses the projector to project the image as provided or modified by previous steps. Processing continues by step E-140. The camera is used to obtain a snapshot of the projected image at the step E-140. At the step S-150, the projected image c_{i,f} is extracted and transformed by process analogous to the initialization steps of obtaining correction data b_{i,j}. The first step of that process can be skipped if the projection area information is stored in the correction data memory. The projected image is subtracted from the original image \tilde{b}_{i,j}=c_{i,j}−(a_{i,j}+ b̅_{i,j}) to see if further improvement of the correction data b₁₁ is required. Step S-150 subtracts the snapshot of the projected image from the original image to decide if the difference is close to white noise.

The decision step D-160 evaluates differences between the original and projected image \tilde{b}_{i,j} against quality criteria. Ideally the matrix \tilde{B} contains white noise only indicating that the correction was successful. If the contents of \tilde{B} differs from white noise significantly then the image \tilde{B} has to be inverted and added to the correction matrix B̅. If the match between the original and projected image is satisfactory, then the correction process ends. The whole process can immediately be repeated (R-180) for the next image or the next frame of the video from the step S-120 by a shortcut through D-110 due to the use of the preserved correction data on the computer memory of the device. If the match between the original and projected image evaluated in the step D-160 is not satisfactory, then the difference between the original and projected image is inverted and merged with the correction data. Processing continues at the step E-130 to obtain a corrected image meeting threshold matching criteria.

Using this method of image correction, the projected image is actively adapted as the projector is operating, whereby irregular projection surfaces do not overly distort the projected image. A wall color (or color pattern) underlying the projection image and surface texture of the wall is actively handled, whereby reflectivity distortions are corrected in the pixels of the projected image. Therefore the projector can project against a number of surfaces and the projected image will be adapted to reduce distortions by each unique surface. Ambient room light is harmful to the method, as the image taken of the camera is reduced and the projected image clarity is reduced. However, if the projector intensity is much higher to account for the room lighting, this effect is small.

To accomplish these steps, a computer processor having a programmed logic is utilized to process the camera and projector image and compute the adaptation for each outgoing image. The following is a pseudocode that provides a means for deploying and enabling the present method:

Pseudocode Outline

| 1. | Start of program | |
|---|---|---|
| 2. | Check if the persisted correction data is available (not available on the 1^{st} execution) | |
| | [D-110] | |
| | a. | // the persisted correction data is available: |

| | |
|---|---|
| i. | // Superimpose persisted correction data over the image/frame [S-120] |
| | for each row i and for each column j { a_with_correction_{i,j} = |
| | (a_{i,j} + b̅_{i,j});} |

| | |
|---|---|
| b. | // the persisted correction data is available (1^{st} execution): |

| | |
|---|---|
| i. | Is initialization requested? [D-210] |

| | |
|---|---|
| 1. | // the initialization is requested |

| | |
|---|---|
| a. | Project calibration image(es) |
| b. | Obtain snapshot of the projection area B [E-220] |
| c. | // Invert the snapshot of the projected area |
| | for each row i and for each column j { b̅_{i,j} = invert(b_{i,j});} |
| d. | Persist B̅ in correction data |
| e. | // Superimpose correction data over the image/frame [S- |
| | 230] |
| | for each row i and for each column j |
| | { a_with_correction_{i,j} = (a_{i,j} + b̅_{i,j});} |

| | |
|---|---|
| 2. | // the initialization is not requested - use the original image as |
| | the corrected image: |

for each row i and for each column j { a_with_correction_{i,j} =
(a_{i,j});}

| 3. | Project the a_with_correction image [E-130] | |
|---|---|---|
| 4. | Obtain snapshot of the projection area B [E-140] | |
| 5. | // compare the original image with the snapshot [S-150] | |
| | for each row i and for each column j {\tilde{b}_{i,j} = c_{i,j} − a_{i,j}} | |
| 6. | Is the match between the A and C satisfactory? | |
| | a. | // the match is not satisfactory |

| | |
|---|---|
| i. | // merge inverted differences with correction data [S-310] |
| | for each row i and for each column j { b̅_{i,j} = b̅_{i,j} + \tilde{b}_{i,j});} |
| ii. | Persist B̅ in correction data [M-170] |
| iii. | // Superimpose correction data over the image/frame [S-230] |
| | for each row i and for each column j { a_with_correction_{i,j} = |
| | (a_{i,j} + b̅_{i,j});} |
| iv. | Continue at 3. (Project the a_with_correction image) |

| 7. | Is there a next image or video frame to be projected? | |
|---|---|---|
| | a. | // there is an image or video frame to be projected: |
| | | Continue at 1 with the new image/frame (that will lead to 2.a.i.) |
| | b. | // no more images to be projected |

| | |
|---|---|
| 8. | End of program. |

The present invention discloses a projector that prevents images from being distorted when viewed on an uneven or colored wall with the use of adaptive projection area correction. A specially equipped camera equipped projector manipulates and adapts the projection image so that it may be clearly seen on an uneven or colored surface. The image of the projection area is obtained, inverted, and superimposed over the image or video intended for projection. The projected image with the correction is captured by the camera again and analyzed for residual imperfections. Consequently the superimposed image and the superimposing coefficient are improved. The invention gives a user the freedom to show a film or make a presentation without having to lug around a projector screen.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An actively adaptive projector system, comprising:
a projection surface
an image projector comprising,
a memory;
a microprocessor;
a storage media;
a digital projector, wherein said digital projector projects a projection image onto said projection surface, and wherein said projection image is reflected off said projection surface as a reflected projection image;
a camera, wherein said camera creates a camera image of said reflected projection image.

2) The system of claim 1, wherein said camera image is a digital image having pixels corresponding to said reflected projection image on said projector surface.

3) The system of claim 1, further comprising an initialization control image for system calibration whereby said projection image is a white image.

4) The system of claim 1, further comprising a projection correction logic, which compares said camera image to said projection image.

5) The system of claim 4, wherein said projection correction logic instructs said microprocessor to modify said projection image if said projection image and said camera image are not the same.

6) The system of claim 1, The device of claim 1, wherein the pixel resolution of said camera is at least the same as the pixel resolution of said projector.

7) A method of actively correcting a projection image based on a projection surface, comprising the steps of:
projecting an image onto a projection surface;
capturing a reflected projected image from said projection surface using a camera;
comparing said projected image with said reflected projection image capture from said camera;
correcting said projection image light and color to reduce reflectivity distortions of said reflected projection image from said projection surface.

8) The method of claim 7, wherein comparing said projection image with said reflected image capture from said camera further comprises the steps of:
mapping pixels of said image capture with pixels from said projected image.

9) The method of claim 7, wherein comparing said projection image with said reflected image capture from said camera further comprises the steps of:
superimposing an inversion of said reflected image capture over said projection image.

10) The method of claim 7, further comprises the steps of:
initializing said projected image by first projected a white image to calculate correction data for subsequent projection images.

11) The method of claim 7, further comprising the steps of:
utilizing persisted correction data for correcting subsequent projection image light and color reflectivity distortions from a previous reflected projection image from said projection surface.

12) The method of claim 7, further comprising the steps of:
comparing said corrected projection image with said reflected projection image capture to calculate differences and determine a satisfactory match, set within a predetermined criteria.

13) The method of claim 12, further comprising the steps of:
merging said calculated differences with said correction data and superimposing over said projection image;
capturing a second reflected projected image from said projection surface using said camera;
comparing said projected image with said reflected projection image capture from said camera;
correcting said projection image light and color to reduce reflectivity distortions of said reflected projection image from said projection surface
comparing said corrected projection image with said reflected projection image capture to calculate differences and determine a satisfactory match, set within a given criteria.
